(19) United States
(12) Patent Application Publication
(10) Pub. No.: US 2018/0374023 A1
(43) Pub. Date: Dec. 27, 2018

(54) SYSTEM FOR CREATING IDEAL EXPERIENCE METRICS AND EVALUATION PLATFORM

(71) Applicant: Lextant Corporation, Columbus, OH (US)

(72) Inventors: Chris Rockwell, Columbus, OH (US); Keytin Palmer, Columbus, OH (US); Mark Palmer, Columbus, OH (US)

(21) Appl. No.: 16/014,973

(22) Filed: Jun. 21, 2018

Related U.S. Application Data
(60) Provisional application No. 62/523,094, filed on Jun. 21, 2017.

(51) Int. Cl. G06Q 10/06; G06Q 30/02

(52) U.S. Cl. CPC G06Q 10/06395; G06Q 10/0637; G06Q 30/0201

(57) ABSTRACT

The present invention is a system for producing ideal experience metrics and associated evaluation platform to objectively compare competing products (or services) or prototypes using a unique scoring algorithm. Consumer feedback data is provided to the system of the present invention to determine an objective score for each criterion. The system may also determine an overall score for the product or service being evaluated. Using the present invention, a provider of a product or service may objectively compare a feature or attribute of the product or service to competing products or services through the use of rated Benefits, Features, and Attributes.

### CROSS-REFERENCE TO RELATED APPLICATION

This application is a non-provisional patent application and claims priority to U.S. provisional patent application No. 62/523,094 filed on Jun. 21, 2017, the contents of which are incorporated by reference as if fully recited herein.

### TECHNICAL FIELD

Exemplary embodiments of the present invention relate generally to the identification of product or service features that trigger favorable emotional responses in those individuals using the product or service and evaluating a product or group of products by a scoring algorithm of the present invention to provide an objective comparison.

### BACKGROUND AND SUMMARY OF THE INVENTION

New or improved product releases are key to the success of businesses. In order to maintain market share, a business offering products or services must continue to offer new and improved products or services. Depending upon the product or service type, the introduction of new products may be required to be performed with relative regularity.

In the current market environment for most products, product quality is a given. Product quality has been improving steadily since the mid-1980's when various quality enhancement programs were instituted by manufacturers. Those manufacturers that didn't implement quality programs rapidly lost market share. Prior to that time, a high-quality product was a selling point that could differentiate one manufacturer or service provider from its competitors. Generally, these higher quality products were more expensive than lower quality alternatives. However, consumers would often see the benefit of the higher quality products despite the higher price. As the result of various quality control efforts such as Six Sigma and Kaizen, the quality gap between high quality, high price products and good quality but lower priced products has narrowed. Currently, a consumer can select from a wide variety of high quality and reasonably priced products. Desirable product features and attributes are required.

The product space beyond quality is that of product features and usability. In order to justify a higher price or to gain market share from competitors, a product or service offering must have features that set that product or service apart from other offerings; such a product must also be user friendly. That is, it must be at least somewhat intuitive in its operation so as to facilitate a user's understanding of how to use the product. As such, manufacturers wishing to offer higher priced products or to gain market share in the more moderate product price categories must look beyond having a high-quality product. But there is still an area of product characteristics that goes beyond even features and usability. That area is the emotions that are triggered when a consumer considers or interacts with a product or service. The emotional response triggered by a product can have a tremendous impact on the thought process of a potential buyer. These emotions ideally result in an increased desire to own or utilize a product or service. For example, buyers of a certain type of luxury product may wish to feel an extra level of safety or perceived ease of use for a particular product. These perceptions may result of certain characteristics of the product even if, in actuality, the product is no more safe or easy to use than a competing product. The materials selected, the characteristics of the controls, the look, the feel, the sound, and in some cases, even the smell of the product may be critical. Manufacturers must analyze and understand their customer's desires in order to offer products that provide the attributes that result in a customer desiring to own or utilize the manufacturer's products or services. In other words, a clear understanding of the opportunity provided by or the problem that is solved by the product is needed. A company that expends development resources on a product that is not accepted by consumers because of the consumer's perception of the product or service may lose market share to other products or services which have more desirable product attributes. In addition to costing market share, offering a product that doesn't inspire a favorable emotional response may damage the reputation of the company offering the product or service such that later products or services may have difficulty recovering the lost market share, even if those later products have more desirable features than competing products. Therefore, designing for a customer's desired experience is required to be successful.

At the same time that manufacturing process improvements were improving product quality, product production and prototyping technologies were evolving. These new technologies allowed for rapid prototyping of new designs and equally rapid production configuration capabilities. The result of these changes is that new product offerings are much more rapid than they have been in the past. Where new products and features could be developed and introduced gradually and deliberately in the past, the current market requires a product or service company to continuously introduce new products and features in order to remain competitive in the marketplace.

Despite the relative ease of prototyping and manufacturing new products or new product features, these efforts are still costly and consume valuable engineering resources. As such, a manufacturer or service provider cannot afford to introduce products without a significant understanding of how their customers may perceive these products. The introduction of a product with features that are less desirable than they could be requires as much time and resources as a product with more desirable features. In addition, those competitors manufacturing similar products very likely have the same rapid prototyping capability and also would be working to introduce new and improved products. As a result of this, expending resources and time developing new products with less than optimal features can result in an organization developing products that are less optimal than their competitors. In addition to the cost involved, these products are less able to compete in the marketplace and will result in less revenue to invest in the next product iteration. As a result, the organization's product offerings could remain stagnant while competing products continue to gain market share. As can easily be understood, the result could be a slow death spiral of lost market share for those companies that fail to understand and provide those product benefits desired by their customers.

Thus, the need for quality is presumed and product offerings have evolved to the point where a plethora of novel features are required for a product to compete against other available products and those features must function with overall characteristics of the product in order to satisfy the buyer's emotional needs with regard to the product. These features must be well thought-out and targeted to appeal to the customer. Finally, despite the fact that rapid prototyping technologies are readily available, the cost to develop and produce such new products remains high. As a result, the market for a product or service is generally competitive enough that missteps in terms of product features can be costly.

What is needed is a system for objectively scoring products or services, or particular features thereof, as a comparison to competing products or services or as a comparison of prototype iterations. In an exemplary embodiment of the invention, features of a luxury vehicle are compared to competing vehicles by data collection over a wide range of stimuli. The examples below are intended to be demonstrative of the inventive system are not intended to limit the present application beyond the scope of the claims. The system of the present invention uses collected data on behaviors, and collected data on desired experiences, to understand attributes that signal the desired experience (e.g., sensory cues, benefits, and features). Then a framework is built from the collected research data to identify concepts and to measure experiential outcomes. The resultant output is used for design development to improve consumer experience and therefore improve business outcomes.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a graphical representation between the emotions that a consumer wishes to experience and the sensory cues of a product or service that ultimately result in those emotions;

FIG. 2 is a flow chart illustrating the high-level steps performed by an embodiment of the invention;

FIGS. 3A and 3B are a flow chart providing a detailed illustration of the steps performed when building a research driven framework and conducting the research;

FIG. 4 is a flow chart illustrating the steps performed to normalize and assign codes to data collected from panel participants;

FIG. 5 is a diagram of a computerized system for determining an objective product attribute score;

FIG. 6 is a flow chart depicting the steps for creating ideal experience metrics and evaluation platform.

### DETAILED DESCRIPTION OF EXEMPLARY EMBODIMENTS

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

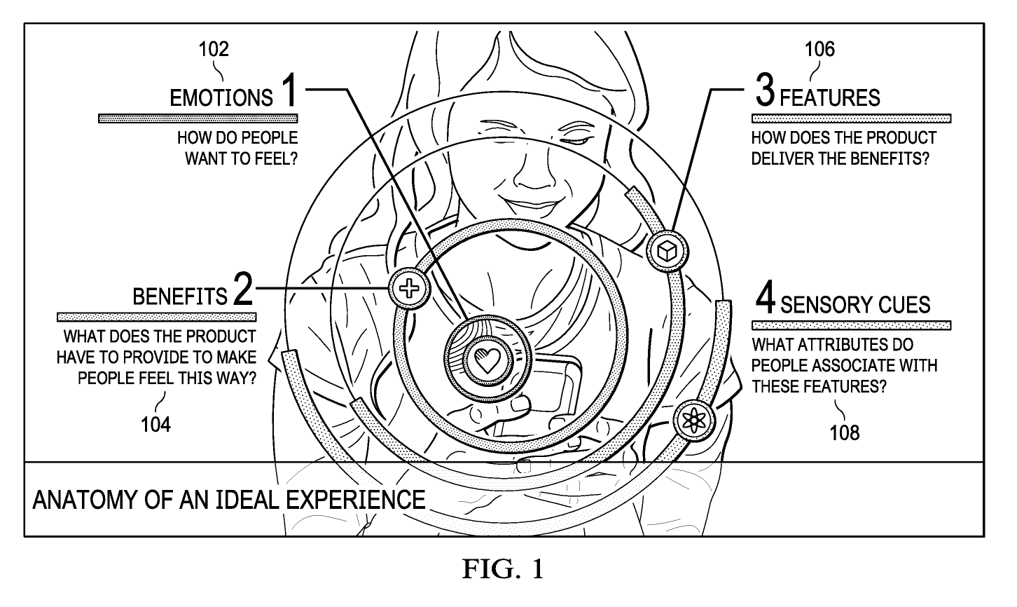

An ideal product experience can be visualized as an interconnected framework of insights that connect key emotions to specific design attributes. FIG. 1 illustrates a graphical representation of an ideal product or service experience as identified using the framework described herein. As illustrated, the emotions 102 that result from interactions with the product or service are central to the concept of the ideal experience. This could also be thought of as the brand promise. In other words, what do consumers want to feel when considering the product or service? As described herein, identifying how a consumer wants to feel is key to creating the ideal experience in a product or service. Once the desired emotions are identified, product benefits 104 that result in the desired emotions may be determined. These benefits are what is provided by the product that result in the emotions defining the ideal product experience. Benefits are generally provided by product features 106. Features might include certain ways that a product might interact with a consumer. For example, the ability to customize a user interface or a particular product function. Finally, there may be certain attributes that are associated with the product features. These may be referred to as sensory cues 108. Examples of sensory cues might be the shape or feel of a control.

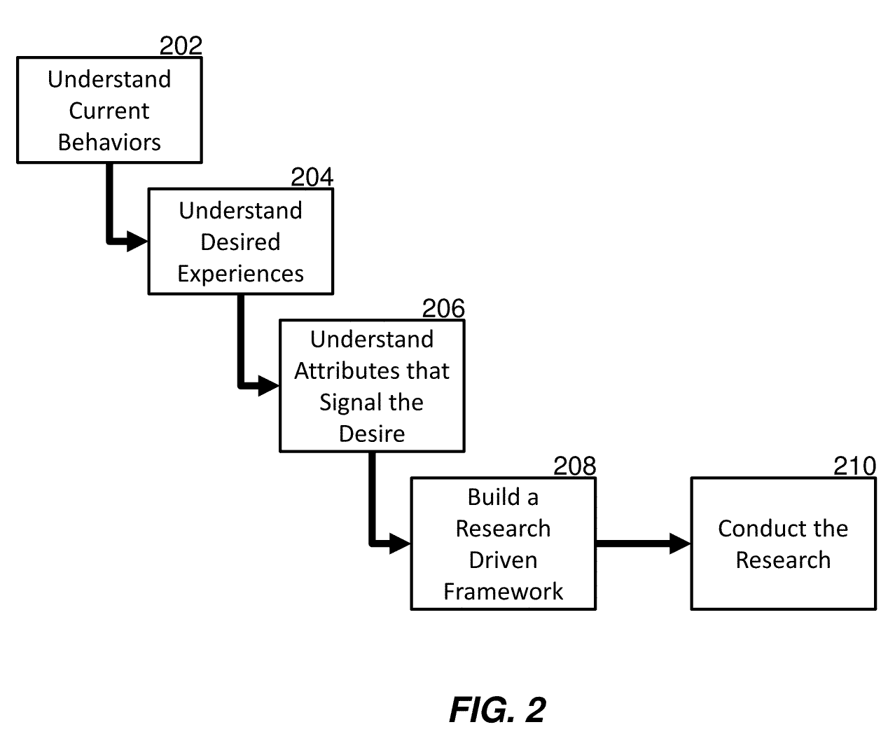

FIG. 2 illustrates a flow chart of the steps that may be performed when implementing the invention. Step 202 is the process of understanding a consumer's current behaviors. These behaviors help to identify the consumer's expectations of the product or service experience generally. These could be thought of as baseline behaviors. Step 204 is the understanding of the consumer's desired experiences. This was illustrated in FIG. 1. Step 206 involves the understanding of what attributes signal the desired experiences. In other words, what about a product provides the desired experience to a consumer? Once these steps are performed and an understanding of behaviors, desired experiences and the attributes that provide those experiences, a framework can be built that enables researchers to understand how a product or service may result in the experiences desired by consumers 208. Once this step is complete, consumer research may be conducted 210 based on the framework to establish a data pool for comparing prototypes and competitive products.

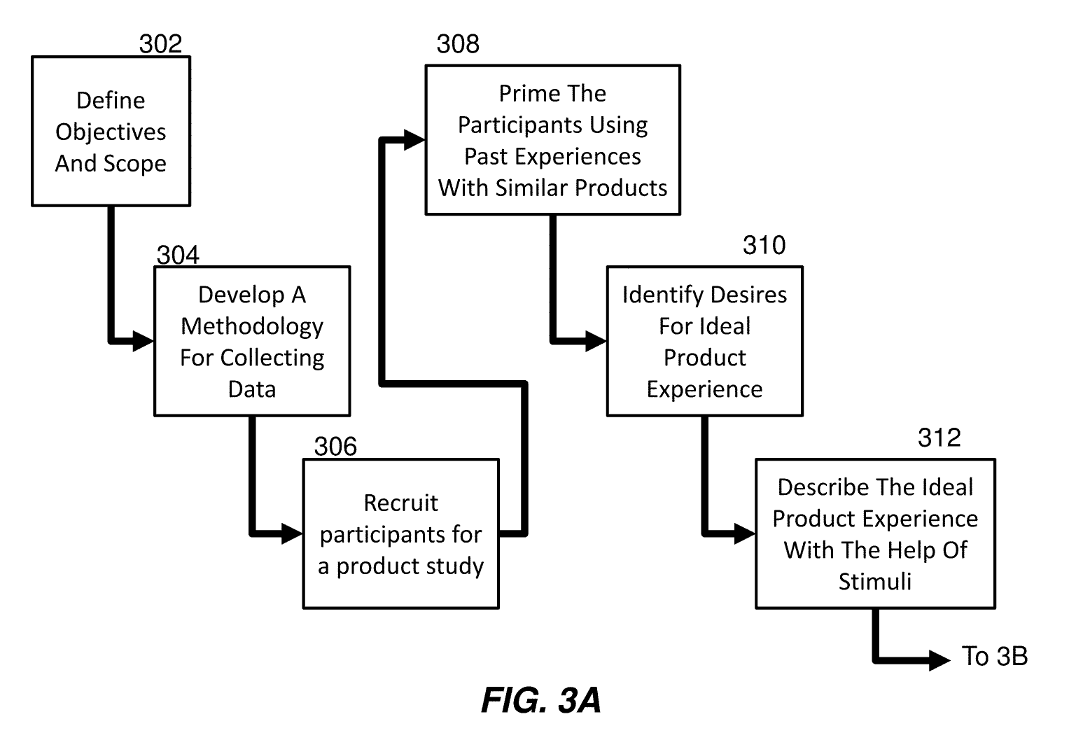

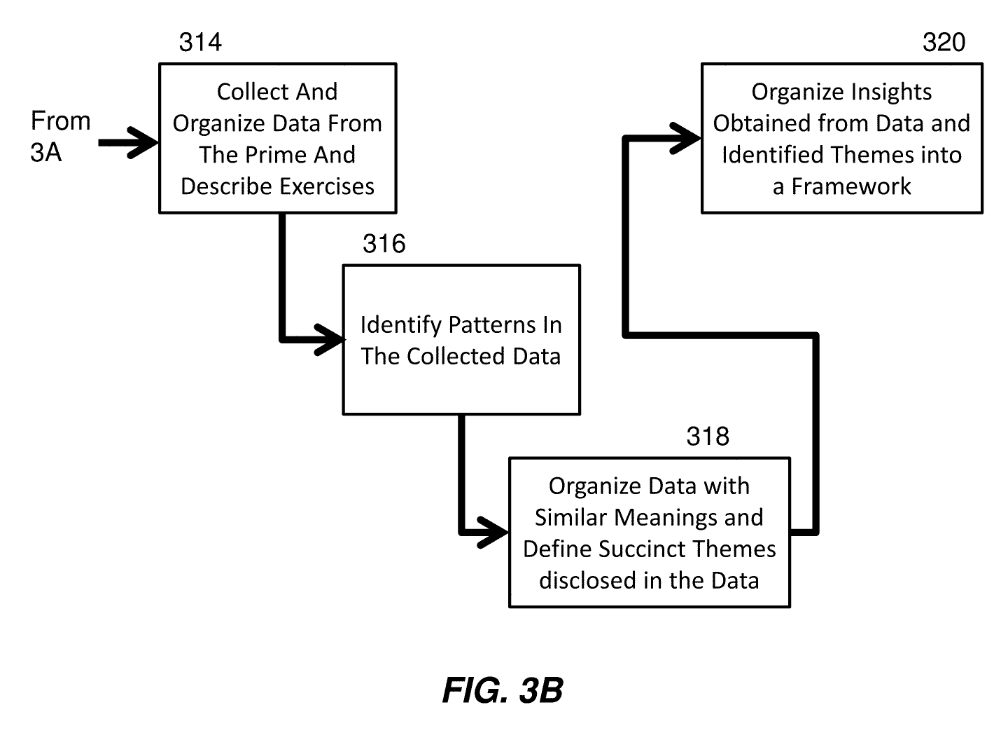

Referring to FIGS. 3A and 3B, step 302 is the definition of the objectives and scope of a particular framework generation. This step serves to identify the subject and set limits on the scope of the research.

As is illustrated at 304, the next step may be the development of a methodology for collecting data regarding the emotions, benefits, features, or sensory cues. This methodology may include the identification of research activities and the development of a set of associated tools, such as factor analysis, cluster analysis, or co-creation methods, for such research. The methodology should be repeatable and scalable such that it may be applied to various groups of potential or actual product users with consistent results. In addition to tools, the methodology may comprise projective exercises and multi-sensory stimulus where these components may be applied in order to provide a complete understanding of a program participant's current and ideal experience with regard to a product or service.

As the method of generating an ideal experience framework features interviews with various persons, step 306 includes the recruitment of these persons.

In some embodiments, those participants selected in step 306 are primed by being immersed in their past and present experiences with the products or service type. This step may generate an increased awareness of the product or service such that the user becomes more aware of and thus better able to communicate their feelings with regard to a product or service. Thus, this step may serve to enable the user to more clearly identify and articulate their desired product or service experiences. This immersion process may comprise pre-interview activities and tasks such as journaling and product experience timeline maps. In many instances, the actual content of the journals and timeline maps are less important than the process of a user considering these thoughts and experiences however, these written materials may still be collected as part of the data entry process in step 314.

The next phase of the process involves interviews of various participants to gather data with regard to their ideal product experience. The interview process may comprise two phases. As indicated in step 310, the first phase of the interview process may focus on the exploration of an interviewee's desires for the future with regard to the product or service which is the subject of the research process. This first phase may use projective stimuli and sequential interview progression in order to facilitate a participant's transition into an aspirational mindset where the participant is able to identify desires for their ideal experience with regard to the product or service. Projective stimuli may include words, images, items or scents that provoke thoughts of an ideal product or service experience. Projective stimuli may assist a panel member to express their feelings with regard to a desired product experience. An example of projective stimuli used for purposes other than identifying a panelist's desires with regard to a product is the Rorschach inkblot test. As with that tool, the projective stimulus is concerned not with the stimulus but with the way the subject responds to the stimulus. However, in the present invention, the stimuli are used to provide a framework for responding to a product's characteristics and features.

In the second part of the interview process 312, participants are again provided projective stimuli and prompted to use the stimuli to develop an expression of the ideal product or service experience with regard to the defined scope of the research. As this second part of the interview process continues, the participant is asked to describe why a projective stimulus evoked a particular feeling with regard to the product. The result is a narrative of the participant's ideal experience using words that relate to the projective stimulus objects. The words used in this narrative are recorded. The feelings with regard to the stimuli are less important than how those feelings are expressed. For example, if a stimulus object has a dark surface, the user may indicate that the object may be easy to clean because it doesn't show fingerprints. The participant is expressing the benefit “easy to clean” by describing the stimulus object. Thus, the identification and collection of words used by participants to describe the stimulus object with regard to a product benefit are the key pieces of information sought in this step.

In step 314, the narratives from a plurality of participants are collected and entered into a database. This step may also include the entry of participant experience timeline maps and journal entries from step 308. The entered information generally comprises the expressions used by the participants to describe their ideal experience. The information also includes how the stimulus objects are described with regard to the attribute that they represent to the participant. Once this information is captured and recorded in a database, the database entries are normalized and assigned codes.

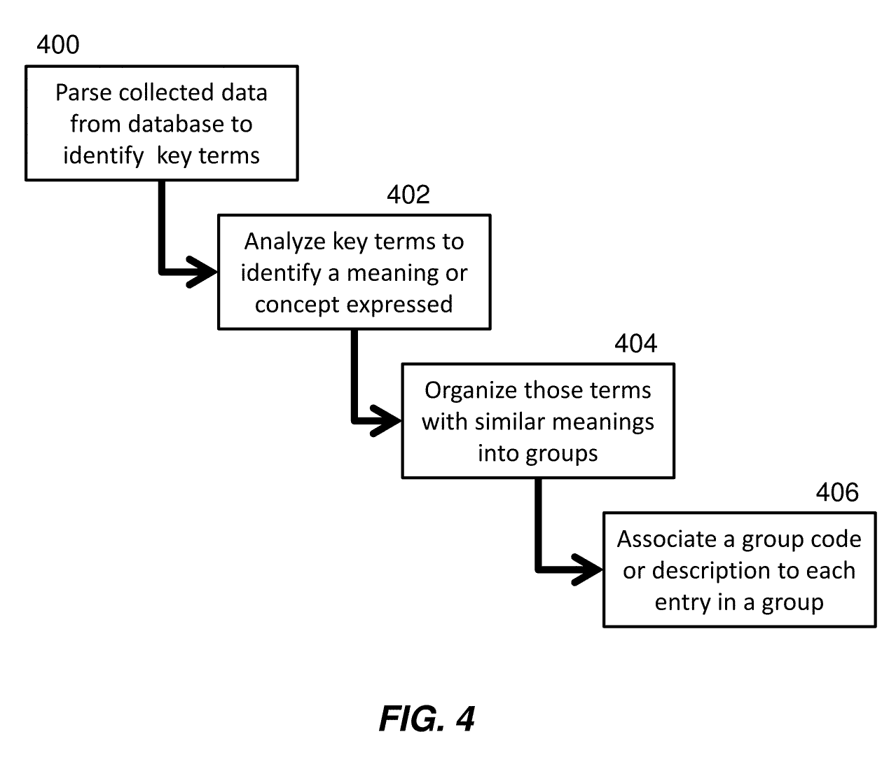

A high-level summary of the steps of this normalization process are illustrated in FIG. 4. In step 400, database entries are parsed to identify the primary terms in each response. In step 402, these primary terms are analyzed to identify their core meaning and then to identify other entries with similar meanings. The entries are organized into groups according to their meaning 404 and an identifying code or description is associated with each entry 406. This normalization process facilitates a review of entries by highlighting groups of entries that, while they may use different terms to describe a feeling, are similar in their conveyed meaning.

In step 316 of FIGS. 3A and 3B, the normalized database entries are systematically analyzed to identify patterns in the participant data. The analysis may be conducted by applying tools such as affinity diagrams, co-occurrence models and frequency counts. One of ordinary skill in the art will understand that other pattern recognition techniques may be applied without deviating from the spirit of the invention.

Once participant response patterns are identified, the patterns may be made available for further review by researchers in step 318. In addition to the identified patterns, the raw response data may also be presented to assist reviewers in understanding the relationships between the data and the identified patterns. The information may be further organized to further group together data with similar meanings. Reviewers may then analyze the available data in order to define succinct themes. These themes are then further consolidated into meta-themes. Reviewers then prioritize key insights and identify strengths, weaknesses, gaps and opportunities that are disclosed by the organized data.

In step 320, the themes and identified relationships are translated into an insight framework. Such frameworks are organized into a single visual diagram that permits the sponsor of the research to quickly identify the key themes and key terms used to describe those themes. In some circumstances, the themes may overlap such that the benefits may have some themes and terms that are common to both. Other means of presenting the result of the previously described analysis may be the creation of process flow diagrams, storyboards, or other narratives, which represent the relationships between the themes. The framework may include expressed desires and high-level benefits and features that support the desired experience. As part of step 320, the identified themes may be further examined to identify any further relationships among the themes, such as hierarchy.

As shown at step 326, once the ideal experience has been defined, product or service concepts can be evaluated using the ideal experience as a framework upon which to structure the concept evaluation.

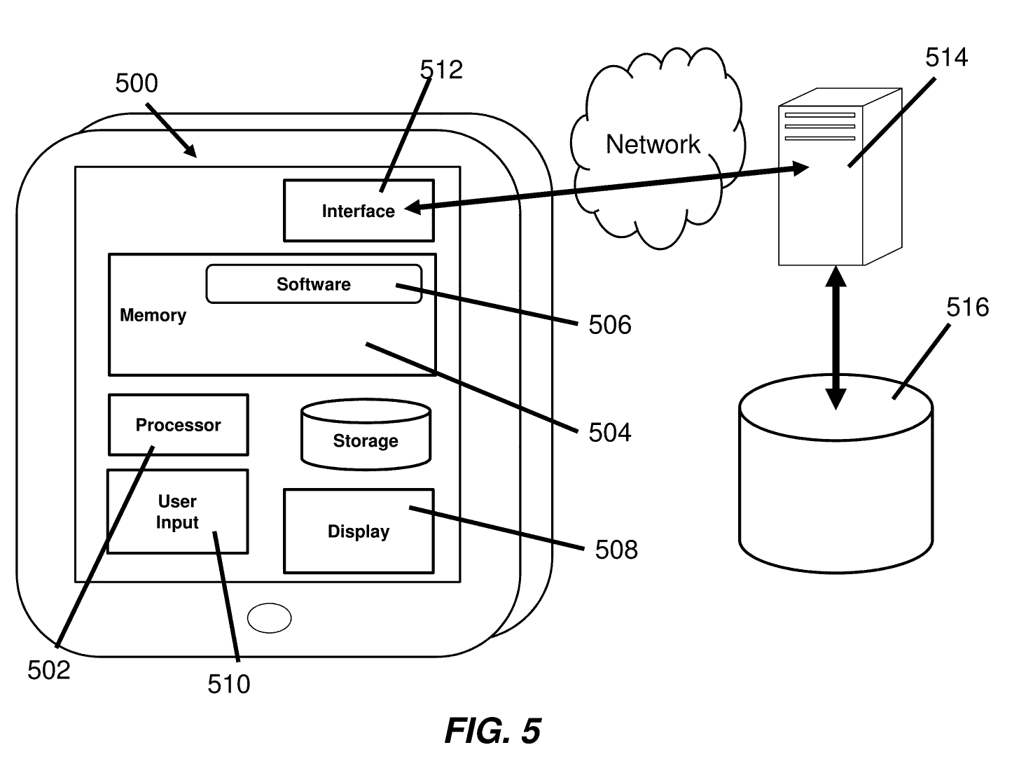

FIG. 5 illustrates an embodiment of a computerized system for receiving panel member feedback or analyzing data through the inventive platform. As is shown, the computerized system 500 may comprise a processor 502, memory 504, software instructions 506, a display device 508, and at least one user input device 510. The computerized system may also comprise an interface 512, which may be wireless, that allows the computerized system to exchange data with a server 514 and database 516. This computerized system may be, without limitation, a laptop, a tablet or other mobile device.

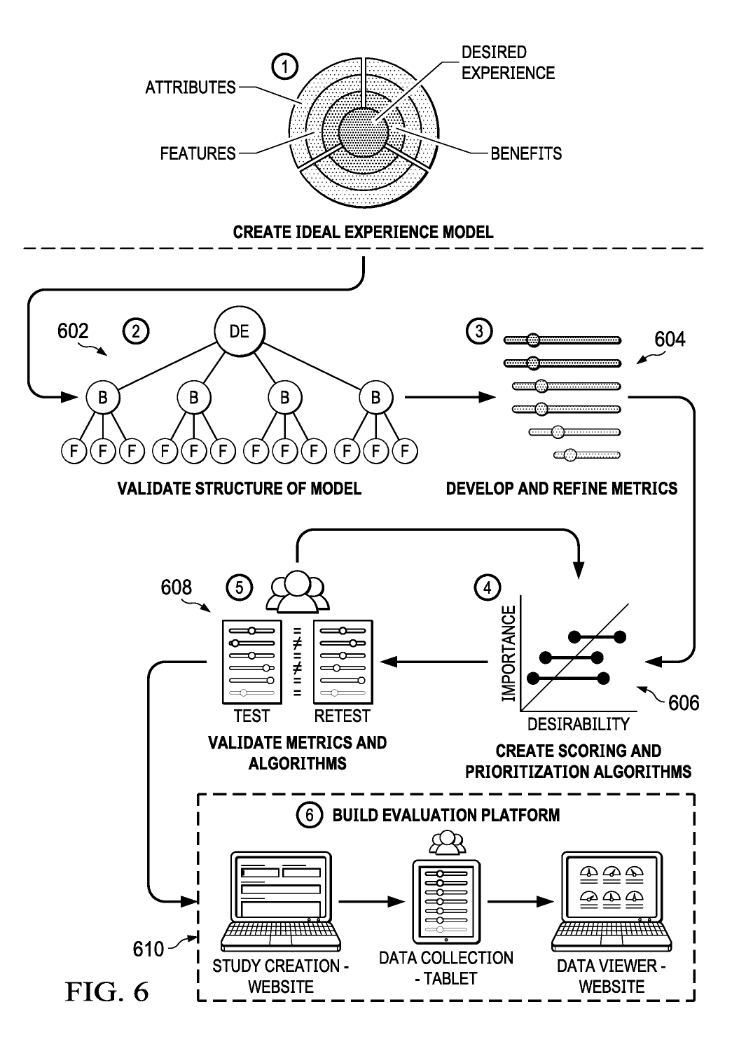

As was illustrated in FIG. 3B, step 320, the insights obtained from the panel interview process detailed are organized into a framework listing emotional benefits, features, and sensory cues. FIG. 6 illustrate the steps associated with this process. In step 602, the framework structure may be validated. One way to validate the structure is to use factor analysis for other statistical corrective tool to ensure lower level elements are under the proper higher-level elements. For example, two higher level categories may be “Beautiful” and “Instinctive.” The initial framework may have a lower-level element of “Thoughtfully Crafted” under the element “Beautiful.” Yet, “Thoughtfully Crafted” may lead to more than one higher level element and to ensure that “Thoughtfully Crafted” is under the proper category a factor analysis may be conducted in association with other lower level elements within the categories to determine the proper place for “Thoughtfully Crafted.” Further, the structure may be verified to have established boundaries between Emotions, Benefits, Features, and Sensory Cues, so as not to blur lines between the separate categories.

In step 604, the metrics may be developed and refined for use in a product comparison. Based on the framework, a questionnaire may be developed to establish desirability ratings for Emotions, Benefits, Features, and Attributes in the experience model. A questionnaire may also be developed to establish the participants current experiences or importance levels for a given quality.

In step 606, scoring and prioritization algorithms are created. This may be done by using a combination of desirability ratings, importance ratings, weights, or performance data. The overall scoring algorithm may be used to give the tester an easy comparison between two separate products or services. At this stage, data may undergo normalization procedures to easily combine various responses, such as transforming data into aggregates or percentages. Weights may be given to individual categories based on importance data or regression analysis. Randomly generated data may be used to test the scoring algorithm created to ensure it is properly derived and any necessary adjustments are timely made. At this stage, grades may be assigned to defined ranges to better visualize the data. For example, a Likert scale ranging from 0-10 may have the ranges 9-10 for “A,” 7-8 for “B,” 6 for “C” and 0-5 for “F.” One of ordinary skill in the art will recognize that various grades and rating range assignments may be used to better represent comparative data and the present example should not be interpreted to limit the present invention in any way beyond those elements presented in the claims. Furthermore, a prioritization algorithm may also be derived to focus on the most important elements for improvement. Using the importance rating as a guideline, an improvement gap method may be used to determine which Benefit, Feature, or Attribute would be most beneficial to focus on first. The improvement gap method quantifies both the importance and satisfaction of a specific element. By focusing on the element with the most opportunity for growth, the product provider may optimize and prioritize those elements which will have the greatest impact on market perception.

In step 608, the metrics and algorithms are tested and retested to ensure they were created properly. This is done by checking for internal validity and ensuring that two groups of similar participants generate the same scores when evaluating the same system. This is also done by testing for sensitivity and ensuring that scores are not identical when they should be showing at least slight variations across separate product features.

In step 610, an evaluation platform is built. Such a platform may be available through a website hosted in the cloud. The platform may be password protected to ensure the tester's valuable and sensitive market data is used for internal purposes only. The platform will implement the algorithms and metrics that were previously defined and verified. These may be stored in a database and drawn upon by a processor executing software instructions to analyze collected data. The data may also be collected through the platform. This may be done by asking a participant to rate current experience with a product they already own or current importance levels on a Likert scale related to the given product. The scale may range from −5 to 5 where a negative number represents the participants disagreed with that given metric, a 0 score indicating a neutral or neither disagree nor agree with the metric, and a positive score representing an agreement with the metric. One of ordinary skill in the art will recognize that the number range of the Likert scale may be any given range and the respective designations may vary from trial to trial or even question to question. The questionnaires relating to current desirability and importance may be considered a homework step, as the participant is given the questions before testing a product or prototype. The participant is then given a chance to test a product or prototype and given another series of questions to be rated on a Likert scale. Once all data has been collected it may be stored in a database for further use and retrieval. In addition to collecting data on individual aspects of a product, the platform may also be used to test function. In testing the function of a product additional data may be collected such as completion rate, number of errors, or duration. The platform may be used to compare two products or services currently on the market, one product on the market with a prototype, or two prototypes. The platform may perform these comparisons for as many separate prototype or market products data is collected for. The platform will digitally represent the results to the tester. The data viewing tool will allow for customization so that participant data may be manipulated to see various results. For example, a participant pool may be restricted to the 25-35 age limit and refine the metrics accordingly by running the algorithms for the selected pool. Such a system will allow for insight into targeted age groups or any other population classifier. The digitally displayed data may give a score for an individual Emotion, Benefit, Feature, or Attribute, or the data may be aggregated into a single overall score. Lastly, the software will go through quality assurance checks to ensure proper function of the systems.

Finally, a sequence of diagrams is attached that describes the use of the present invention in scoring one or more features of a luxury vehicle as objectively compared to other competing luxury vehicles. The example of a luxury vehicle is not intended to limit the present invention in any way as these systems and methods may be used to evaluate any product or service. Diagram 1 represents the overall development process for developing a luxury HMI scorecard. Diagram 2 represents the objectives completed by the invention as it relates to luxury vehicles. Diagrams 3-9 depict various algorithms and graphic displays of results. Diagrams 10 and 11 depict the study for both in person and online participant data collection and the respective tasks that that participants may be required to complete. Diagram 12 depicts a framework breakdown and questions will be asked to all participants to obtain a rating for each aspect of the luxury model. Diagrams 13-17 are further breakdowns of the framework and pointed questions to be answered by the participant to acquire raw data. Diagrams 18-20 depict a user interface for use of the software platform and possible displays to assist in selecting the desired comparisons. Diagrams 21-26 depict graphical and numerical representations of comparisons after the data has been analyzed. Diagram 27 depicts the overall process from the start of developing the framework until the software platform is verified. Diagram 28 is an example of how a question may be presented to the participant. Diagram 29 is a graphical representation of the improvement-gap method to determine the most import luxury model aspect that can be improved the greatest. One of ordinary skill in the art will recognize that these diagrams directed to luxury models are presented as examples and are not intended to limit the present invention in any way.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for producing relative scores for pre-selected attributes of a product or service, said system comprising:
a. Identification of a subject to optimize;
b. Identification of at least one feature of said subject for analysis;
c. Identification of at least one attribute for said subject;
d. Presentation of external, tangible stimuli, said external tangible stimuli external to and apart from said subject and said at least one feature, to collect and store consumer expressions associated with said at least one objective and said at least one feature, in a database;
e. Analysis of said expressions to generate patterns of themes in said collected expressions; and,
f. Applying a scoring program through a computer processor, to said patterns of themes, to produce a score for said subject attribute relative to at least one other subject having a similar feature.

2. The system of claim 1, wherein said at least one attribute is associated with a measured emotional response.

3. In a system for producing an improved product design, including identification of a subject product to optimize, and identification of at least one feature of said subject product for analysis, the improvement comprising:
a. An arrangement of a plurality of different stimuli, said arrangement of stimuli presented to a plurality of consumers;
b. A data collection subsystem, said data collection subsystem configured to receive individuals' emotional responses from said plurality of consumers, interacting with said plurality of stimuli, and store said responses collected in at least one database;
c. A data sorting subsystem configured to sort said data collected in said data collection subsystem, wherein each said response is classified into at least one type of multiple, predetermined categories of emotional responses;
d. A computer processor configured to process said sorted data to identify patterns within said consumer responses, and to mathematically reduce said patterns to a scale of desirability for each of said stimuli as it pertains to said at least one feature; and,
e. A suggested improvement output subsystem, configured to produce a suggested improvement to said feature, from said scale of desirability.

4. The system of claim 3, wherein said predetermined categories include at least satisfaction, and dissatisfaction, with said stimuli.

5. The system of claim 3, wherein said output subsystem is configured to produce a graphical presentation of desirability of attributes for said feature.

6. The system of claim 3, wherein said arrangement of stimuli is physically apart from said subject and said feature.

7. The system of claim 3, wherein said plurality of stimuli include different materials that are arranged in a way to be touched by consumers.

8. The system of claim 3, wherein said plurality of stimuli include different pictorial electronically produced images displayed on a video display terminal for consumers to view.

9. The system of claim 3, wherein said data collection subsystem includes audio/video capture components.

10. The system of claim 3, wherein said computer processor for identifying patterns includes a word detection software program which detects certain words and the number of times said words are repeated by said consumers.
